(19) United States
(12) Patent Application Publication
(10) Pub. No.: US 2026/0258840 A1
(43) Pub. Date: Sep. 3, 2026

(54) PLAIN BEARING

(71) Applicant: AKTIEBOLAGET SKF, GOTEBORG (SE)

(72) Inventor: Michael WENDEL, Bremen (DE)

(21) Appl. No.: 19/544,005

(22) Filed: Feb. 19, 2026

(30) Foreign Application Priority Data
Feb. 28, 2025 (DE) 102025107629.4

(51) Int. Cl. F16C 33/06; F16C 17/02

(52) U.S. Cl. CPC F16C 33/06; F16C 17/02

(57) ABSTRACT

A plain bearing includes a first bearing element that has a sliding surface configured to slide against a sliding surface of a second bearing element. The sliding surface includes a laser-hardened first surface region that has a first hardening depth. The sliding surface and/or a non-functional surface of the first bearing element may also, optionally, include a second laser-hardened surface region that has a same or different hardness than a hardness of the laser-hardened first surface region.

### CROSS-REFERENCE

This application claims priority to German patent application no. 10 2025 107 629.4 filed on February 28, 2025, the contents of which are fully incorporated herein by reference.

### TECHNOLOGICAL FIELD

The present disclosure relates to a plain bearing, in particular a large plain bearing having, for example, a diameter of more than 380 mm. The large plain bearing is suitable, in particular, for use in wind power or hydroelectric power applications.

### BACKGROUND

Plain bearings can be used in different technical fields, wherein, depending on the field of application, different demands are placed on these plain bearings.

In particular in the case of a plain bearing that is subjected to high loads, for example in the wind power or hydroelectric power sector, the raceway/sliding surface has to be hard and wear-resistant. By contrast, other faces may remain untreated (in the condition as delivered). The sliding surfaces of the plain bearing may slide against one another or against different bushings, thrust washers, strips, sliding shoes, or be separated by a lubricant film, for example an oil film.

In order to provide corresponding hard and wear-resistant faces, the sliding surface can be hardened. For this, it is known practice to subject the sliding surface to a heat treatment.

However, conventional heat treatments, such as martensitic hardening, bainitic hardening, case hardening, nitriding or induction hardening, have notable drawbacks, These include: batch processes (apart from induction hardening) without a flow of single pieces, large-scale equipment/furnaces which are required for large rings (which are not readily available), significant warping results in a significant oversize for the soft component and expensive reworking, significant effort for parts handling and logistics, surface damage requires hard machining to remove damaged surfaces (for example decarburization, oxidation, etc.), specific, parts-related tool costs and costs associated therewith (for example inductors for induction hardening), long retooling times when changing production parts, no selective hardening possible (exception: induction hardening), requirement for floor area for heat treatment plants, and high energy demand (exception: induction hardening).

Furthermore, for some of the abovementioned heat treatment methods, no suitable furnace sizes are available, in particular for large rings.

### SUMMARY

Therefore, the present disclosure addresses the problem of providing a plain bearing, the sliding surfaces of which can be manufactured and hardened in an energy-efficient and cost-effective manner, and for which it is possible to dispense with laborious reworking.

In the following text, a plain bearing is presented which has at least one face that has a first surface region which has been laser-hardened to a first hardness depth. The hardness depth should be understood as being the region in which, on account of the heat input by the laser, a phase transformation of the starting material from a ferritic matrix into a martensitic microstructure occurs. In other words, during the laser hardening of the first surface region, a transformed peripheral portion extending over the first hardness depth arises in this region, this being adjoined by the untransformed matrix. It is particularly advantageous here when the first hardness depth is less than 2 mm, in particular approximately 1 mm deep.

As a result of the use of laser hardening, the abovementioned drawbacks are overcome. Furthermore, in the case of large bearings having a diameter of more than 100 cm, the advantages in relation to energy efficiency and handling are obvious, as will be explained in more detail in the following text.

During laser hardening, the steel components are locally heat treated such that a primarily martensitic microstructure is created by rapid laser heating and subsequent cooling by heat conduction. If necessary for geometric reasons and/or because of the limited hardenability of the steel used, additional quenching media (for example compressed air or water) may be used in order to increase the quenching speed.

Laser hardening is characterized by limited energy/heat input and thus low energy consumption and associated low CO₂ emissions, low warping and limited or zero surface oxidation. This affords the possibility of skipping subsequent machining steps for removing surface damage, for example oxide layers/decarburized surfaces/scale that would arise in conventional hardening processes, and to integrate the hardening process into the soft machining. As a result, the lead time and the effort for handling and logistics in the manufacturing chain, in particular for plain bearings with a large diameter, can be reduced.

Furthermore, laser hardening is characterized by high energy density and a short process time. It is likewise advantageous that only a small volume is affected, or only a small part of the workpiece cross section is treated, and that no process gases are required. As already mentioned above, it is also possible, in the case of laser hardening, to dispense with quenching of the workpiece after heating, since quenching occurs by heat conduction in the component. This has the advantages that no quenching medium and thus also no pumps for quenching or cooling of the plant are required. A further advantage of the rapid cooling of the small heated material volume is the possibility of being able to use cost-efficient steels that have a small CO₂ footprint, as a result of a relatively only low content of required alloying elements or only a low required potential hardness increase. Furthermore, the same laser source and optics can be used for different workpiece geometries, and so it is possible to dispense with or significantly reduce parts-specific tooling.

A further advantage of laser hardening is that, during laser hardening, only very little warping, if any, arises in the bearing component, and so it is possible to partially or entirely dispense with expensive reworking, in particular laborious hard machining. This also has the advantage that a smaller material allowance is required since less deformation occurs, this implying better material utilization and also saving costs.

Furthermore, the laser-hardening process can be integrated into the soft-machining sequence (for example turning, milling, etc.), i.e. into the machining prior to the actual hardening and/or the hard-machining process (for example grinding, honing), i.e. the machining after the hardening, with integration into existing machines even being possible.

Furthermore, a flexible laser-hardening device can also be integrated into the soft machining - but also into the hard-machining unit -, and this can reduce the cycle time and significantly increase productivity. This is important particularly in the field of large bearings, where the effort for handling and logistics is relatively significant and expensive.

Since, especially in the plain bearings, the sliding surface, i.e. the functional face, is particularly loaded, an exemplary embodiment in which at least one of the at least one face is a sliding surface which is in sliding contact with a sliding partner of the plain bearing is advantageous in particular.

In contrast to rolling bearings, in which the relatively cost-effective hardening process can be used only to a limited extent for the raceway or the functional face, since the hardness penetration depth that can be achieved with laser hardening is usually insufficient in order to cover the Hertzian stress, the hardness penetration depth that is achievable for the sliding surfaces with laser hardening is entirely sufficient.

Preferably, the laser-hardened region extends over the entire contact face of the tribological pairing. The hardness depth may, however, gradually decrease in an outer region of the region to be hardened, as long as the required surface hardness is achieved over the sliding contact.

Preferably, the surface hardness of an inner and outer ring in the sliding contact is at least equal to or higher than that of the sliding partner.

In addition to the laser hardening of the sliding surfaces, it may also be advantageous, however, in the case of non-functional faces, i.e. faces that are not used for the tribological pairing, to harden these in order, for example, to protect them particularly against wear. Thus, an exemplary embodiment in which at least one of the at least one face is a non-functional face, wherein the non-functional face is subjected, in the assembled state, to contact with an element bearing on the plain bearing or is in contact with an element receiving the plain bearing, is also advantageous.

The non-functional face may, in this case, be in particular an inside-diameter face of an inner ring, an outside-diameter face of an outer ring, a lateral face of a bearing ring, and/or a flange of a bearing ring.

As a result of the laser hardening of the functional (sliding surface) or non-functional face, it is possible for wear marks to be avoided for example during assembly. Likewise, it is possible, as a result of the laser-hardened surfaces, to avoid damage caused by wear particles or bearing component damage in the event of creep movements between the bearing component and the surrounding component. Furthermore, the wear in the case of movements or in the case of sliding contacts between the bearing components and/or between a bearing component and an element receiving the bearing component can be reduced overall on account of the laser-hardened surface region, this increasing the lifetime of the bearing components and of the bearing overall.

Furthermore, a microstructural phase change occurs during laser hardening, and this results in a change in the specific volume and a change in the density of the physical phases, for example in the case of the transformation into martensite and/or bainite. Thus, the hardened and transformed surface regions have a greater volume than in the starting phase and result in a micrometre-range elevation of the laser-hardened surfaces. As a result, it is possible in turn for the press fit and/or the friction to be increased, in particular at contact faces with surrounding components, for example a shaft or a housing, such that the components are exposed to less in the way of creep movements.

Furthermore, “craters” can be created in the surface topography, in that the material is locally melted and the melt evaporates (laser engraving). The increased specific volume of the martensitic peripheral layer furthermore creates residual compressive stresses in the peripheral zone, these counteracting crack initiation and crack propagation.

The increase in the coefficient of friction can also make it possible, however, for the press fit or the force fit itself to be reduced, since the high coefficient of friction ensures an equally good form fit between the components. A lower press fit or a smaller contribution of the force fit in turn results in lower tensile stresses in the bearing component (for example inner ring shrink-fitted onto a shaft), this in turn resulting in a longer component lifetime.

Furthermore, an increased coefficient of friction between the bearing component and the surroundings (for example housing/shaft) caused by the texturing of the surface can contribute to the avoidance of movements (for example ring creep), with the result that the lifetime of the bearing component can be increased.

The laser hardening of the functional and/or the non-functional face can be carried out by one or more laser heads.

According to a further advantageous exemplary embodiment, the face has at least one second surface region, wherein the second surface region has been laser-hardened to a second hardness depth, wherein the second hardness depth is less than the first hardness depth.

Alternatively or additionally, the face may also have at least one third surface region, wherein the third surface region has not been laser-hardened.

As mentioned above, a microstructural phase change takes place during laser hardening, this resulting in a change in the specific volume and a change in the density of the physical phases, for example during the transformation into martensite and/or bainite. The hardened and transformed regions have a larger volume than in the starting phase and result in a micrometre-range elevation of the laser-hardened surfaces.

In the process, more “deeply” hardened surface regions are elevated higher than less “deeply” hardened surface regions or surface regions that have not been hardened at all. In other words, the first surface region is elevated higher than the second surface region and/or the third surface region. Likewise, however, the second surface region is also elevated higher than the third surface region.

As a result, a particular surface texture and topology can be applied. Alternatively, as a result of sufficient heating and the creation of local melt pools, it is also possible for material to be removed/evaporated and for a texture to be created as a result (laser engraving).

Of course, it is also possible for further surface regions with further different hardness depths to be provided, in order, for example, to further refine the surface texture.

Thus, as a further preferred exemplary embodiment discloses, the first and the second and/or third surface region may be arranged in such a way that the second and/or third surface region forms a lubricant reservoir and/or a lubricant channel that is delimited by the first surface region. This contributes advantageously to wear reduction at sliding contacts. Furthermore, it is possible, as a result, to ensure that lubricant can be retained at particular points on the plain bearing component, in particular at particular points on the sliding surfaces, and/or can be guided to particular points in the plain bearing component, in particular to particular points on the sliding surfaces.

It is thus possible to create, for example, a “golf-ball topography” in order produce lubricant channels and to improve the lubrication conditions as a result. As mentioned above, this can be achieved either by selective hardening of local regions or by a different hardness depth, or by local melting. The resultant recesses act as lubricant reservoirs.

This behaviour or this property can also be used in order to create textures for increased friction on non-functional contact faces, in order, for example, to avoid a relative movement between rings and contact partners (housing/shaft). As a result of a form fit or a friction fit with a very high coefficient of friction, which impedes the relative movement of bearing and counterpart in use, a lower press fit/a lower contribution of the force fit can be achieved, this in turn resulting in lower tensile stresses in the bearing component (for example inner ring shrink-fitted onto a shaft) and a longer component lifetime.

Therefore, an exemplary embodiment in which the at least one face is a non-functional face and the first surface region laser-hardened to a first hardness depth has a first coefficient of friction and the second surface region hardened to a second, less deep hardness depth and/or the non-laser-hardened third surface region has/have a second and a third coefficient of friction, respectively, wherein the first coefficient of friction is higher than the second and/or third coefficient of friction, is also advantageous.

As a result of the specific increase in the coefficient of friction of the bearing component at particular points, the relative movement between the bearing component and a counterpart (for example a shaft/housing) in use can be made more difficult. The increase in the coefficient of friction and also the particular configuration of the surface texture can allow a lower press fit or a smaller contribution of the force fit, this in turn resulting in lower tensile stresses in the bearing component and a longer component lifetime.

According to a further advantageous exemplary embodiment, the first surface region is in a continuous form.

As a result, it is possible for the plain bearing to be embodied without a soft point on its entire circumferential surface, thereby ensuring, for example, a uniform increase in coefficient of friction and thus uniform force transmission. This can be achieved with one or more laser heads.

Alternatively, it may, of course, also be advantageous for the first surface region to be in the form of separate surface region portions.

It is thus possible, for example, for a soft, non-laser-hardened, region to be provided on the entire circumferential surface between start and end positions of a scanning operation, or even for a plurality of soft regions to be allowed, which form a particular pattern. Thus, it is possible, for example, for the hardening to be in the form of a plurality of rectangles/squares, a plurality of circular/oval points, a plurality of triangles, or of zigzag shapes, optionally with different angles.

In this case, the patterns can include further functions, for example the abovementioned lubricant reservoirs or channels. However, they can also be configured as specific designs which, for example, purely visually assign the bearing to the applicant as manufacturer.

According to a further preferred exemplary embodiment, the laser-hardened surface region has at least one soft point or soft joint, wherein the soft point/soft joint is arranged in an unloaded region of the laser-hardened surface region and/or wherein the soft point/soft joint is arranged at an angle to a loading direction.

There may be one soft point/soft joint or a plurality of soft points/soft joints.

Such a soft point/soft joint may also arise, for example, in that a previously hardened region is heated once again. This can occur, for example, in that the laser that scans the face to be hardened passes once again over regions of the face to be hardened that have already been heated and cooled again. Such soft points are not absolutely vital in particular in plain bearings, since the entire face serves as a sliding surface and local small-scale soft points are not vital when the sliding surface has otherwise been hardened.

As a result, the hardening process can be considerably simplified, since it is possible to dispense with complex plant technology or process control, in particular also for preheating, or the like, which would be required for slip-free hardening, i.e. hardening without a soft point or soft joint.

In principle, the surface region to be hardened can be hardened by means of laser hardening with a soft joint or without a soft joint.

If possible, preference is given to the technically simpler process, the hardening process with a soft joint for the raceway/sliding surface hardening. In particular when permanent contact of the sliding bodies can be avoided (for example in hydrodynamic or hydrostatic plain bearings), a soft joint can be accepted.

All non-functional surfaces can be hardened with a soft joint.

The soft point or soft joint is oriented preferably in an axial direction or perpendicularly to the overrolling/load direction.

In order to achieve a better load and stress distribution, it is possible, as a further preferred exemplary embodiment discloses, for the soft joint to be embodied at a different angle than parallel to the axial direction of the ring.

If the plain bearing executes an oscillating movement of less than 360°, typically +/- 5° - 40°, the soft joint can also be positioned in the unloaded zone.

According to a further preferred exemplary embodiment, the plain bearing has a bearing ring split at at least one joint face, wherein at least one soft point is provided preferably next to the joint face. The laser beam hardening device can also be used in order to create, at the joint face, a local groove for crack initiation for the subsequent, deliberate separation (laser notching).

If one of the plain bearing rings is split for assembly reasons, laser hardening is particularly advantageous, since the volume into which internal stresses are introduced by the laser hardening is much smaller than in the case of conventional hardening, this resulting in less deformation when the bearing rings are separated. The deformation during separation arises as a result of the releasing of the internal stresses that are introduced into the bearing ring during heating/hardening. In particular in the case of inductive hardening, the internal stresses may be so great that laborious reworking is required after separation, or, in the worst case, the bearing ring as a whole is unusable.

Furthermore, it is advantageous when the bearing ring to be separated, in addition to the joint face, has a soft joint. This can be arranged next to the split, which is located outside the loaded zone. As a result, the deformation brought about during the releasing of the internal stresses caused by the separation can be counteracted particularly well, since no internal stresses or only insignificant internal stresses have been introduced in the region of the soft joint.

Furthermore, an exemplary embodiment in which the plain bearing has a first sliding partner with a first sliding surface and a second sliding partner with a second sliding surface, which are in sliding contact with one another at their respective sliding surfaces, wherein the first sliding surface and the second sliding surface each have a first surface region which has been laser-hardened, wherein a hardness of the first surface region of the first sliding surface and a hardness of the first surface region of the second sliding surface have a substantially identical laser-hardened hardness, is advantageous.

When both sliding partners have the same hardness, it is possible to ensure that one of the two partners does not become excessively worn while the other partner experiences no wear or only little wear.

Furthermore, it is advantageous when a component of the plain bearing, which has the surface with the laser-hardened surface region, is manufactured from a quenched and tempered steel.

Typical steel grades are all hardenable steel grades with the following range of chemical composition:

carbon (0.30 - 1.10% by weight), and/or

silicon (0.10 - 1.0% by weight), and/or

manganese (0.10 - 1.50% by weight), and/or

chromium (0.10 - 2.00% by weight) and/or

molybdenum (0.01 - 0.75% by weight).

Particular preference is given to steels of the quenched and tempered steel grade with a carbon content of between 0.3 and 1.1% by weight. These include, in particular, a steel of the specification 42CrMo4. Alternatively, the use of a steel of the specification 50CrMo4 is also advantageous. Such quenched and tempered steels can be hardened particularly readily.

Further advantages and advantageous embodiments are specified in the description, the drawings and the claims. In this case, in particular the combinations of features specified in the description and in the drawings are purely by way of example, and so the features may also exist on their own or in combination.

### BRIEF DESCRIPTION OF THE DRAWINGS

In the following text, the disclosure will be described in more detail with reference to exemplary embodiments illustrated in the drawings. In this case, the exemplary embodiments and the combinations shown in the exemplary embodiments are purely by way of example and are not intended to fix the scope of protection of the disclosure. This is defined only by the appended claims.

FIG. 1 is a schematic sectional view through a plain bearing according to a first exemplary embodiment of the disclosure.

FIG. 2 is a schematic sectional view through a plain bearing according to a second exemplary embodiment of the disclosure.

FIG. 3 is a schematic sectional view through a plain bearing according to a third exemplary embodiment of the disclosure.

FIG. 4 is a perspective view of a plain bearing ring according to a fourth exemplary embodiment of the disclosure.

FIG. 5 is a perspective view of a plain bearing ring according to fifth exemplary embodiment of the disclosure.

FIG. 6 is a perspective view of a plain bearing ring according to a sixth exemplary embodiment of the disclosure.

FIG. 7 is a perspective view of a plain bearing ring according to a seventh exemplary embodiment of the disclosure.

FIG. 8 is a perspective view of a plain bearing ring according to an eighth exemplary embodiment of the disclosure.

FIG. 9 is a perspective view of a plain bearing ring according to a ninth exemplary embodiment of the disclosure.

FIG. 10 is a perspective view of a plain bearing ring according to a tenth exemplary embodiment of the disclosure.

FIG. 11 is a perspective view of a plain bearing ring according to an eleventh exemplary embodiment of the disclosure.

FIG. 12 is a schematic illustration of a surface texture.

FIG. 13 is a perspective view of a plain bearing ring according to a twelfth exemplary embodiment of the disclosure.

FIG. 14 is a perspective view of a plain bearing ring according to a thirteenth exemplary embodiment of the disclosure.

### DETAILED DESCRIPTION

In the following text, identical elements or elements that have a functionally identical effect are identified using the same reference signs.

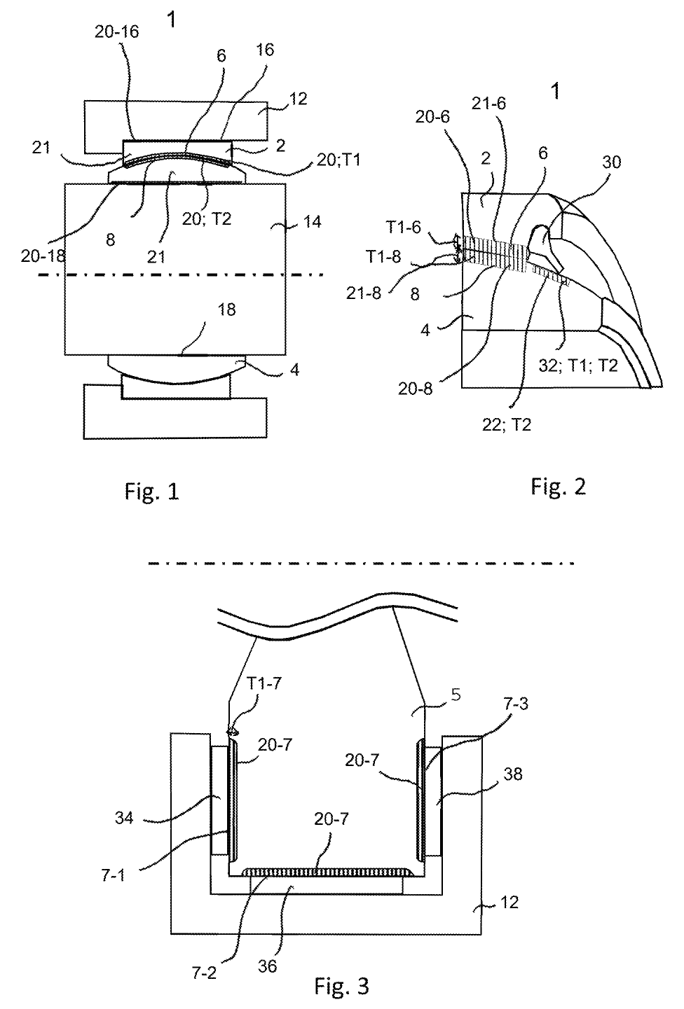

FIG. 1 schematically shows a sectional view through a plain bearing 1 having an outer ring 2 and an inner ring 4, which are in sliding contact with one another at sliding surfaces 6 and 8, respectively. Furthermore, FIG. 1 shows that the outer ring 2 is accommodated in a housing 12, while the inner ring 4 is carried by a shaft 14. Thus, the outer ring 2 is in frictional contact with the housing 12 by way of its outer face 16 and the inner ring 4 is in frictional contact with the shaft 14 by way of its inner face 18. According to the definition of the present disclosure, the sliding surfaces 6, 8 should thus be considered as being functional faces and the contact faces 16, 18 as being non-functional faces.

Furthermore, FIG. 1 and, in more detail, FIG. 2 show that the sliding surfaces 6, 8 have a first surface region 20-6; 20-8, in which the sliding surfaces 6, 8 have been laser-hardened to a first hardness depth T1-6, T1-8.

During the laser hardening, the steel components are locally heat treated such that a martensitic microstructure is created by rapid laser heating and subsequent cooling by heat conduction. This martensitic microstructure extends in the first surface region 20 as far as the first hardness depth T1. Beneath the surface region 20 there follows a matrix 21, i.e. the starting microstructure of the steel, which is only slightly affected, if at all, by the heat treatment by means of the laser.

The martensitic microstructure created by the laser in turn ensures that the bearing ring is much more wear resistant and can withstand significant loads in the first surface region 20 at the sliding surfaces 6, 8.

Preferably, the hardness depth T1-6 and the hardness depth T1-8 are substantially identical.

Optionally, as outlined in FIG. 1, it is also possible for non-functional faces, i.e., for example, the contact faces 16, 18, by way of which the outer ring 2 is accommodated in the housing 12 and the inner ring 4 is in contact with the shaft 14, to have been laser-hardened in a surface region 20-16, 20-18 as far as a hardness depth T1 (see FIG. 1).

Since, during laser hardening, a microstructural phase change takes place, which results in a change in the specific volume and in a change in the density of the physical phases, for example during the transformation into martensite and/or bainite, the hardened and transformed surface regions have a greater volume than in the starting phase and result in a micrometre-range elevation of the laser-hardened surfaces. This in turn makes it possible that, in particular at contact faces 16, 18 with surrounding components, for example the shaft 14 or the housing 12, the press fit and/or the friction is increased such that the components are exposed to less in the way of creep movements. Alternatively, local melting can change the surface topography such that the coefficient of friction is increased by the resultant craters and elevations.

Furthermore, the friction-field-increasing characteristic of laser hardening makes it possible that, as a result, a smaller overlap can be chosen between a bearing ring (e.g. outer ring 2, inner ring 4) and the component (e.g. shaft 14, housing 12) receiving the bearing ring, and yet a comparable, if not better rotationally fixed connection between the bearing component and surrounding component can be achieved. This in turn reduces the tensile stresses in the bearing itself and results in a longer lifetime. The resultant residual compressive stresses in the hardened peripheral layer also result in a longer lifetime.

FIG. 2 shows, in a detail view, a further example, in which the plain bearing 1 additionally has a seal 30, which is fastened to the outer ring 2 and rubs against the inner ring 4 in a region that is not in sliding contact with the outer ring 2, and serves as a thrust surface 32 for the seal 30. The thrust surface 32 may be assigned either to the functional faces, i.e. the sliding surface 8, or to the non-functional faces, since there is no sliding contact with the outer ring 2 here. Regardless of the assignment that is made, it is also possible for the thrust surface 32 of the seal 30 to be subjected to increased wear. It is therefore advantageous to also laser-harden the thrust surface 32.

The thrust surface 32 may have been hardened to the same hardness depth T1 as the sliding surface 8. Optionally, the thrust surface 32 may have been hardened to a second hardness depth T2. Optionally, the sliding surface 4 then has a first surface region 20 with a first hardness depth T1 and a second surface region 22 with a second hardness depth T2.

FIG. 3 schematically shows a further example of a plain bearing 1 with a plain bearing ring 5, which is accommodated in a housing 12 and slides on three sides along sliding shoes 34, 36, 38, which are carried by the housing 12. To that end, the sliding ring 5 has three sliding surfaces 7-1, 7-2, 7-3, which have again been hardened to a first hardness depth T1-7 in the first surface region 20 of the sliding contact.

As mentioned above, as a result of the laser-hardening, a phase transformation arises, which results in a change in volume of the hardened material such that the hardened points stand slightly above of the surface. This fact can also be used to provide the surface with a specific texture, which ensures, for example, that lubricant is retained at specific points or is guided to specific locations.

In this case, in particular at the sliding surfaces 6, 8, it may be particularly preferred to apply a lubricant reservoir structure or lubricant channel structure, which ensures that lubricant remains at the sliding surfaces 6, 8 and is not transported away. As a result, it is also possible for improved emergency running characteristics or lubrication conditions to be achieved at low speeds.

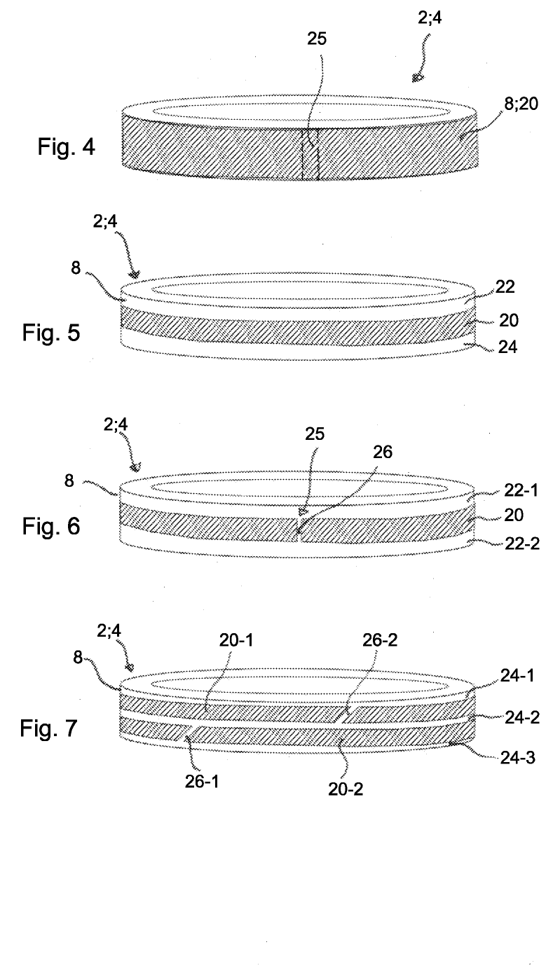

FIGS. 4 – 11 schematically show different laser-hardened sliding surfaces 8 on, for example, an inner ring 4.

Thus, for example, FIG. 4 shows that the first laser-hardened surface region 20 extends over the entire sliding surface 8.

The surface 20 may have been laser-hardened in a slip-free manner, i.e. with no discernible difference in the hardening of the surface 20 around the entire circumference, or with overlap, i.e. with at least one joint 25.

It is likewise conceivable to form the hardness track in a manner distributed in a spiral shape around the circumference, with soft zones remaining between the tracks. Alternatively, the hardness tracks may also be formed in a directly adjacent manner such that the entire face is hardened.

If hardening is not effected in a slip-free manner, it is also possible for a soft (unhardened or reheated after being hardened) joint to be present in the region of the optional joint 25. Such a soft point/soft joint may arise, for example, in that a region that has already been hardened is heated once again. This can occur, for example, in that the laser that scans the face to be hardened passes once again over regions of the face to be hardened that have already been heated and cooled again, or introduces heat into the latter, for example by heat conduction in the case of a very small distance of the laser from the already hardened surface. Such soft points are not absolutely vital in particular in plain bearings, since the entire face serves as a sliding surface and local small-scale soft points are not vital when the sliding surface has otherwise been hardened.

By contrast, FIG. 5 shows that, as already described with reference to FIG. 2, not the entire sliding surface 8 has been uniformly laser-hardened. In the illustrated exemplary embodiment, a first surface region 20, which has been laser-hardened to a first hardness depth T1, a second surface region 22, which has been laser-hardened to a second hardness depth T2, and a third surface region 24, which has not been laser-hardened at all in the illustrated case, are provided. Furthermore, FIG. 5 shows that the laser-hardened surface region 20, 22 extends continuously around the entire bearing ring 2.

In the exemplary embodiment in FIG. 6, by contrast, the laser-hardened surface region 20 does not extend around the entire circumference, and so a gap 26 remains in an end region/joint region 24. Such a gap 26 may arises, for example, when the bearing ring is scanned with the aid of a laser head. Since the laser-hardened face 20 is a sliding surface 8, however, a small unhardened region 26 is not vital, even with regard to the wear properties of the bearing ring.

FIG. 7 shows two laser-hardened surface regions 20-1, 20-2, which laterally and centrally have respective surface regions 22-1, 22-2, 22-3 with a less deep hardness depth T2 and/or regions 24-1, 24-2, 24-3 that have not been laser-hardened. These regions 22, 24 may act, for example, as lubricant channels in order to keep lubricant specifically on the sliding surface or to guide it to the sliding surface.

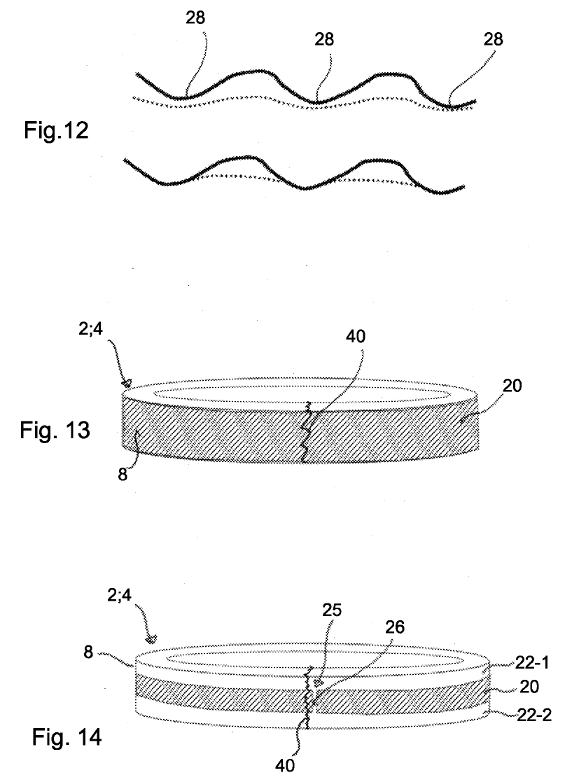

Such lubricant channels or lubricant indentations 28 are illustrated in an enlarged manner in FIG. 12. These arise, as mentioned above, as a result of specific local adaptation of the laser hardening, wherein, in the lubricant indentation region (surface region 22; 24), laser hardening is not carried out (surface region 24) or hardening is carried out only with lower intensity (surface region 22).

As a result, a golf-ball topology can also be applied to the bearing ring, thereby ensuring particularly good reception of lubricant.

Of course, it is likewise possible that, for example, the surface region 22-2 hardened to the second hardness depth T2 is arranged centrally between the surface regions 20 hardened to the first hardness depth, but unhardened surface regions 24-1, 24-3 remain in the peripheral regions of the bearing ring 2.

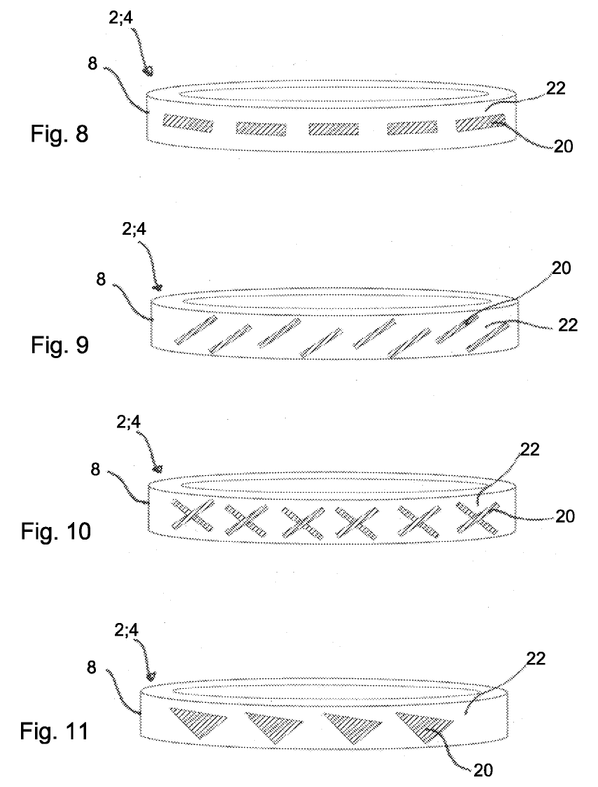

In addition to the more continuously extending exemplary embodiments in FIGS. 4-7, it may likewise be possible to laser-harden only separate regions, as is illustrated in the exemplary embodiments in FIGS. 8-11. Of course, other patterns are conceivable, and so, for example, specific patterns for the assignment of the bearing ring to a particular manufacturer are also possible.

As likewise already mentioned above, the bearing ring 2; 4 may be hardened with or without slip. Furthermore, one or more laser heads may be used.

FIGS. 13 and 14 show further exemplary embodiments, in which the bearing ring 2; 4 has been split for assembly reasons at a joint face 40. Splitting of one of the bearing rings is necessary in particular in the case of large plain bearings in order for it to be possible to assemble the two bearing rings in sliding contact with one another.

In such bearing rings 2;4 that have to be split for assembly reasons, it is particularly advantageous to use laser hardening, since the volume into which internal stresses are introduced as a result of hardening is much lower in the case of laser hardening than in the case of conventional hardening, resulting in less deformation when the bearing rings are separated. The deformation upon separation arises as a result of the releasing of the internal stresses that are introduced into the bearing ring during heating/hardening.

FIG. 13 shows a bearing ring 2; 4 in which the surface to be hardened has been laser-hardened all around the circumference, and the joint face 40 can be arranged circumferentially as desired on the bearing ring 2; 4. Upon installation of the bearing, the joint face 40 can then be arranged, for example, such that the joint face 40 is arranged at a point of the plain bearing that is not loaded or is not loaded much.

FIG. 14 shows a bearing ring in which at least one unhardened region 26 or a region that has been tempered again after hardening, i.e. a so-called soft joint 25 is arranged next to the joint face 40. As a result, the deformation brought about during the releasing of the internal stresses caused by the separation can be counteracted particularly well, since no internal stresses or only insignificant internal stresses have been introduced in the region of the soft joint. In addition, as a result of the provision of one or more soft zones next to the hardened “predetermined breaking point” more targeted crack initiation can be established in the hardened, more brittle microstructure (laser-hardened).

Overall, as a result of the laser hardening, a plain bearing can be provided which has greater wear resistance. At the same time, as a result of the laser hardening, a surface texture can be applied that makes it possible to retain lubricant on the sliding surface, with the result that the lubrication properties of the plain bearing are improved.

Furthermore, during the laser hardening even of the non-functional faces, a relative movement between the bearing component and a component receiving the bearing component can be reduced.

The laser hardening itself can be effected with one or more laser heads and can be integrated preferably into existing machining process, such that additional costly machining steps are not necessary.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved plain bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### LIST OF REFERENCE SIGNS

1 Plain bearing
2, 4 Bearing ring (outer ring, inner ring)
5 Plain bearing ring
6, 8, 7 Sliding surfaces
12 Housing
14 Shaft
16, 18 Contact faces
20, 22; 24 Surface region
21 Matrix
25 End region/joint region
26 Gap
25 Joint
28 Lubricant indentations
30 Seal
32 Thrust surface
34, 36, 38 Sliding shoes
40 Joint face
T1, T2 Hardness depth

What is claimed is:

1. A plain bearing comprising:
a first bearing element having a sliding surface configured to slide against a sliding surface of a second bearing element,
wherein the sliding surface includes a laser-hardened first surface region, and
wherein the laser-hardened first surface region has a first hardening depth.

2. The plain bearing according to claim 1,
including the second bearing element,
wherein the sliding surface of the first bearing element is in contact with the sliding surface of the second bearing element.

3. The plain bearing according to claim 1,
wherein the first bearing element includes a non-functional surface, the non-functional surface including a laser-hardened surface region.

4. The plain bearing according to claim 1,
wherein the sliding surface of the first bearing element has a laser-hardened second surface region, the laser-hardened second surface region being laser-hardened to a second hardening depth, and
wherein the second hardening depth is less than the first hardening depth.

5. The plain bearing according to claim 4,
wherein the sliding surface of the first bearing element has a third surface region, and
wherein the third surface region is not laser-hardened.

6. The plain bearing according to claim 5,
wherein the laser-hardened first and the second surface regions of the first bearing element are arranged in such a way that the laser-hardened second surface region forms a lubricant reservoir and/or a lubricant channel that is bounded on one side by the laser-hardened first surface region.

7. The plain bearing according claim 4,
wherein a coefficient of friction of the laser-hardened first surface region is greater than a coefficient of friction of the second laser-hardened surface region.

8. The plain bearing according to claim 1,
wherein the first bearing element is a bearing ring having an annular surface, and
wherein the laser-hardened first surface region comprises a continuous circumferential strip extending 360 degrees around the annular surface.

9. The plain bearing according to claim 1,
wherein the first bearing element is a bearing ring having an annular surface, and
wherein the laser-hardened first surface region comprises a plurality of laser-hardened subregions separated by not-hardened portions of the annular surface.

10. The plain bearing according to claim 1,
wherein the laser-hardened surface region includes at least one subregion having a hardness less than a hardness of a remainder of the laser-hardened surface region.

11. The plain bearing according to claim 1,
wherein the first bearing element is a bearing ring having an annular surface,
wherein the bearing ring includes a joint at which a first circumferential surface of the bearing ring meets a second circumferential surface of the bearing ring, and
wherein a region of the annular surface adjacent to the joint has a hardness less than a hardness of the laser-hardened first surface region.

12. The plain bearing according to claim 2,
wherein a hardness of the laser-hardened first surface region of the first bearing element is substantially the same as a hardness of the laser-hardened sliding surface of the second bearing element.

13. The plain bearing according to claim 1,
wherein the first hardening depth is less than 2 mm.

14. The plain bearing according to claim 1,
wherein the first hardening depth is 1 mm.

15. The plain bearing according to claim 1,
wherein the first bearing element comprises a quenched and tempered steel grade with a carbon content of between 0.4 and 1.1% by weight.

16. The plain bearing according to claim 1,
wherein the first bearing element comprises a quenched and tempered 42CrMo4 steel or a 50CrMo4 steel.

17. The plain bearing according to claim 1,
wherein the first bearing element is a bearing ring and the sliding surface is annular,
wherein the sliding surface includes a laser-hardened second surface region and a not-hardened third surface region,
wherein the laser-hardened first surface region has a hardness greater than a hardness of the laser-hardened second surface region,
wherein the laser-hardened second surface region has a hardness greater than a hardness of the not-hardened third surface region, and
wherein the laser-hardened first surface region comprises a first annular portion of the annular sliding surface and the laser-hardened second surface region comprises a second annular portion of the annular sliding surface and the not-hardened third surface region comprises a third annular portion of the annular sliding surface.
